(19) United States
(12) Patent Application Publication
(10) Pub. No.: US 2026/0007559 A1
(43) Pub. Date: Jan. 8, 2026

(54) BED PAN CLEANING SHIELD

(71) Applicant: Waimon Innovations, L.L.C., North Kingstown, RI (US)

(72) Inventors: Sarah Waimon, North Kingstown, RI (US); Stephen Gianelis, Barrington, RI (US); Breck Petrillo, Warren, RI (US)

(73) Assignee: Waimon Innovations, L.L.C., North Kingstown, RI (US)

(21) Appl. No.: 19/254,407

(22) Filed: Jun. 30, 2025

Related U.S. Application Data
(60) Provisional application No. 63/732,049, filed on Jul. 8, 2024.
(60) Provisional application No. 63/767,173, filed on Mar. 5, 2025.

(51) Int. Cl. A61G 9/02

(52) U.S. Cl. CPC A61G 9/02

(57) ABSTRACT

A shield device for a bed pan during cleaning using a pivoting water fixture having an arm and a head includes a shield member. The head of a water fixture is received in an aperture through the shield and the arm of the fixture resides in a channel disposed in the shield. The shield is connected to the arm and head of the water fixture. Clamps secure the arm in the channel and, as a result, the head in the aperture so the shield moves with pivoting movement of the water fixture. When the water fixture is in a downward cleaning position and with the water flowing from the fixture, the shield member is positioned over the head of the water fixture to prevent upward splashing of water and debris up from the bed pan toward a person cleaning the bed pan using the water fixture.

### CROSS REFERENCE TO RELATED APPLICATIONS

This application is related to, and claims benefit from, U.S. Provisional Patent Application No. 63/732,049, filed on Jul. 8, 2024, entitled “BED PAN CLEANING SHIELD,” and U.S. Provisional Patent Application No. 63/767,173, filed on Mar. 5, 2025, entitled “BED PAN CLEANING SHIELD,” both of which are incorporated by reference in their entirety, herein.

### BACKGROUND OF THE INVENTION

The present invention relates to bed pans. More specifically, the present invention relates to the cleaning of bed pans in way that reduces the exposure of bodily fluids to the person that is cleaning the bed pan.

Bed pan cleaning devices are well known. These devices are commonly used in a hospital setting, long/short term care facilities, and the like. For example, FIG. 1 shows a close-up view of a common bed pan cleaning fixture 10 which is configured for being plumbed directly into the water supply for a toilet 12. These are commonly known as bedpan diverter fixtures. FIG. 2 shows this common bed pan cleaning fixture 10 installed inline with a common toilet in the flush valve centerline, namely between the flush valve 16 and the entry port 18 of the toilet 12. In FIG. 2, the custom bed pan water fixture 10 is plumbed to a toilet 12 and is shown in an upright position where an internal valve in the bed pan cleaning fixture (not shown) is open so water, flowing from the water supply and through the internal valve when actuated, flows directly into the toilet 12.

FIG. 3 shows the bed pan cleaning fixture 10 pivoted to a downward position ready for use when the arm 20 of the fixture 10 is in this downward position an internal valve is actuated to thereby bypass the flow of water 22 through the arm 20 of the water fixture 10 and then out through the spray head 26 thereof. Such outflow of water 22 through the spray head 26, preferably in a spray form is shown in FIG. 4 where the spraying water 22 is directed to a bed pan 24 (not shown in FIG. 4) in an open, unprotected fashion. A bed pan 24 is held underneath the water spray 22 to wash out the contents therein. The operation of this known bed pan cleaning fixture 10 and how it is used to clean a bed pan 24 is so well-known that further discussion herein is not required. As can be understood from FIG. 4, the problem identified is the high exposure to bodily fluids by way of spray back while cleaning bed pans 24, urinals, and measuring devices with the current systems because the spray head 26 of the fixture, from which the water 22 is sprayed, is completely exposed.

Therefore, there is a need to protect a caregiver, such as a medical professional, from being exposed to feces, urine, body fluids, and other contaminants, while cleaning a bed pan.

There is also a need to facilitate and reduce the time to clean a bed pan by a caregiver.

There is another need in industry to easily and simply connected a shield device to an existing water fixture for cleaning bed pans where the shield device moves with the pivoting action of the water fixture.

Yet another need is to be able to connect a shield device to an existing water fixture in a fixed fashion so it is automatically positioned in place when the fixture is moved into a cleaning position.

### SUMMARY OF THE INVENTION

The present invention provides a device and method to address the shortcomings and problems associated with cleaning of bed pans.

The shield device of the present invention is for protecting the user during cleaning of the bed pan using a common pivoting water fixture with a fixture head from which water flows, such as in the form of a spray. The shield device of the present invention includes a shield member that preferably includes a downwardly depending outer wall about the periphery of the device and a downwardly depending inner wall about the aperture of the device that receives the head of the water fixture. The head of a water fixture is received in an aperture through the shield and the arm of the fixture resides in a channel disposed in the shield. The shield is connected to the arm and head of the water fixture. Clamps secure the arm in the channel and, as a result, the head in the aperture so the shield moves with pivoting movement of the water fixture while twisting of the water fixture relative to the shield device is reduced or even eliminated. For use of the water fixture to clean a bed pan, the water fixture is in a downward horizontal cleaning position and with the water flowing from the fixture, the shield member is positioned over the head of the water fixture to prevent upward splashing of water and debris up from the bed pan toward a person cleaning the bed pan using the water fixture.

Therefore, an object of the present invention is to protect a caregiver, such as a medical professional, from being exposed to feces, urine, body fluids, and other contaminants, while cleaning a bed pan for a patient or individual under their care.

There is another object of the present invention to facilitate and reduce the time to clean a bed pan by a caregiver.

There is yet another object of the present invention to easily and simply connected a shield device to an existing water fixture for cleaning bed pans where the shield device moves with the pivoting action of the water fixture.

Another object of the present invention is to connect the shield device to the existing water fixture in a fixed fashion so it is automatically positioned in place when the fixture is moved into a cleaning position.

### BRIEF DESCRIPTION OF THE DRAWING FIGURES

Further advantages, features and possible applications of the present invention are shown and described in the accompanying drawing figures.

FIG. 1 is a front perspective view of a standard bed pan water fixture that is commonly plumbed in line with an existing toilet.

FIG. 2 is a front perspective view of a standard bed pan water fixture plumbed in line with a toilet with the water fixture in a non-use upright position.

FIG. 3 is a front perspective view of a standard bed pan water fixture plumbed in line with a toilet with the water fixture in a lowered in-use position.

FIG. 4 shows the water fixture of FIG. 1 in a lowered in-use position with water turned on and flowing downwardly.

FIG. 5 is a top perspective view of the shield device of the present invention.

FIG. 6 is a bottom perspective view of the shield device of FIG. 5.

FIG. 7 is a front elevational view of the shield device of FIG. 5.

FIG. 8 is a right side elevational view of the shield device of FIG. 5.

FIG. 9 is a rear elevational view of the shield device of FIG. 5.

FIG. 10 is a top perspective view of the shield device of the present invention with a bed pan cleaning water fixture installed therein.

FIG. 11 is a bottom perspective view of the shield device of FIG. 5 with a bed pan cleaning water fixture installed therein.

FIG. 12 is a front elevational view of the shield device of FIG. 5 with a bed pan cleaning water fixture installed therein.

FIG. 13 is a right side elevational view of the shield device of FIG. 5 with a bed pan cleaning water fixture installed therein.

FIG. 14 is a rear elevational view of the shield device of FIG. 5 with a bed pan cleaning water fixture installed therein.

FIG. 15 is a cross-sectional view through the line 15-15 of FIG. 10.

FIG. 16 is a cross-sectional view though the line 16-16 of FIG. 10.

FIG. 17 is a cross-sectional view through the line 17-17 of FIG. 10.

FIG. 18 shows a perspective view of the shield device of the present invention installed on a water fixture on a toilet that is in a stowed upright position.

FIG. 19 shows a perspective view of the shield device of the present invention installed on a water fixture on a toilet that is in a lowered in-use position.

FIG. 20 shows a perspective view of the water fixture in a lowered in-use position with shield device attached thereto during cleaning of a bed pan.

FIG. 21 shows a perspective view of the water fixture and shield device attached thereto being pivoted up and away after cleaning.

FIG. 22 is a perspective view of the water fixture and shield device attached thereto in an upright stowed position while the bed pan is being emptied.

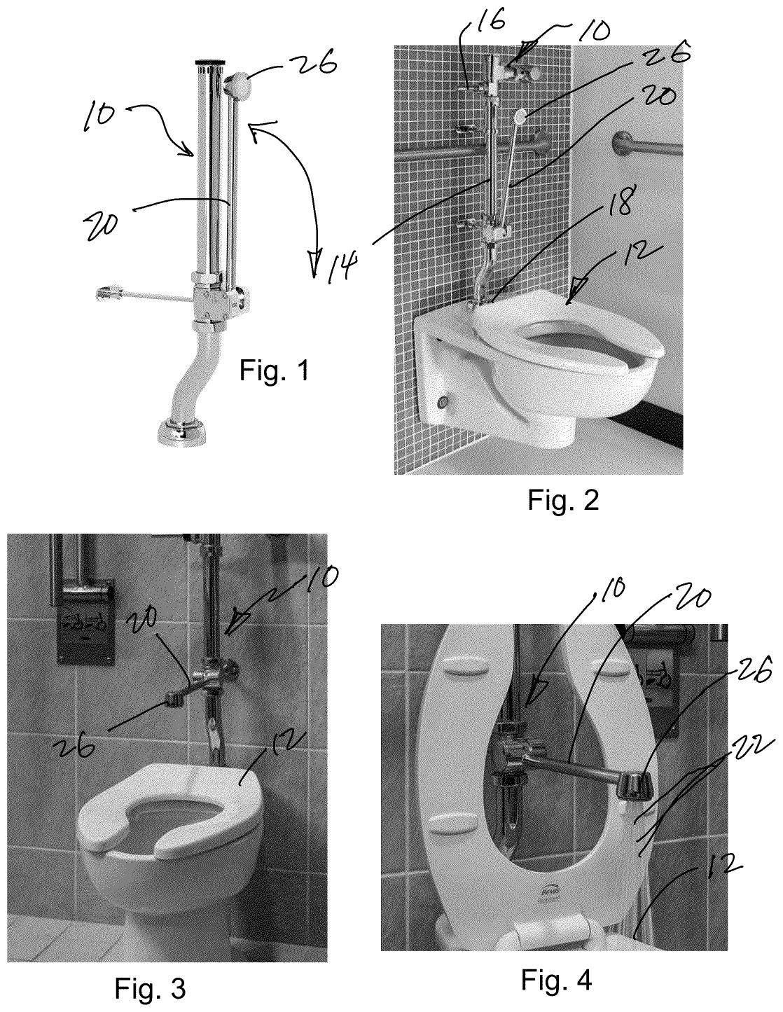

### DESCRIPTION OF THE INVENTION

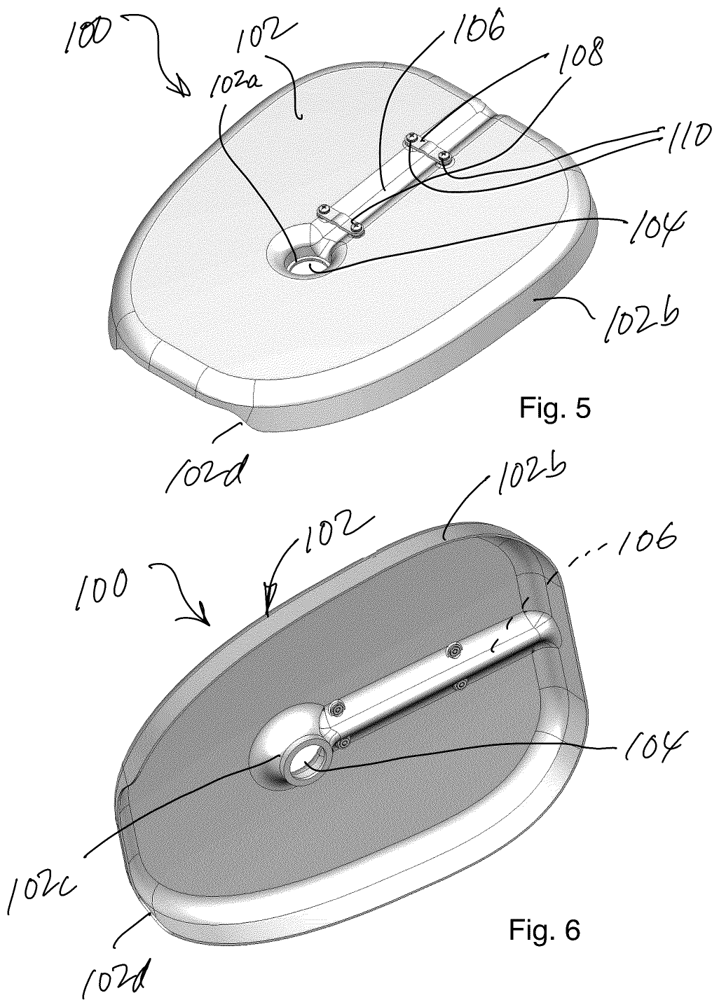

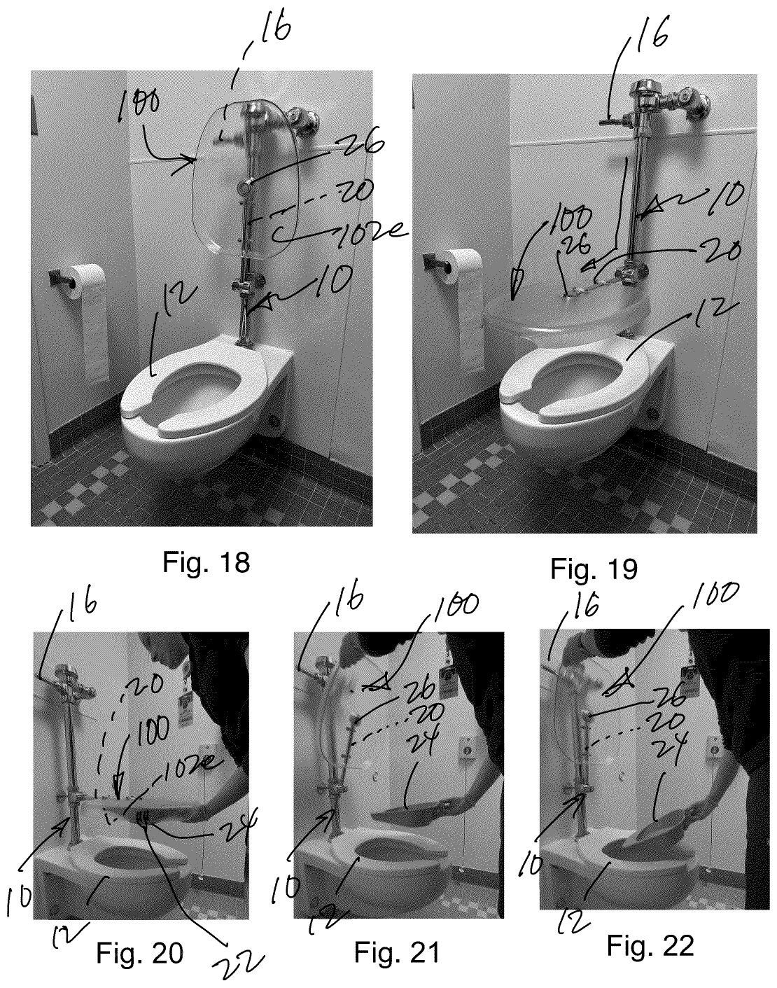

As shown in the attached FIGS. 5-17, the present invention provides a new device 100 in the configuration of a universal fit shield device that is attached to an industry standard existing bed pan water fixture/diverter 10 that is plumbed inline with a common hospital or industrial type toilet 12 in the flush valve centerline 14, namely between the flush valve 16 and the entry port 18 of the toilet 12 itself. Operation of the shield device 100 of the present invention is shown in FIGS. 18-22.

By way of background, the shield device 100 of the present invention is affixed to nozzle arm 20 of the water fixture 10 to prevent fluid spray from reaching the caregiver while cleaning a bedpan 24 over the toilet 12. The device 100 may be attached to a wide array of different sizes and type of water fixtures 10 that are used for bedpan cleaning. During the cleaning operation, the shield 100 resides between the person cleaning the bed pan 24 and the impact of the water spray 22 of the fixture 10 into the bed pan 24. Thus, the device 100 prevents fluid from spraying out the sides and upward toward the caregiver thereby protecting the caregiver during the cleaning operation.

Referring first to FIG. 5, a top perspective view of the shield device 100 of the present invention is shown. The shield device 100 has a shield member 102 that is preferably planar but may be other shapes and still carry out the present invention. The periphery is preferably of the general shape of a toilet bowl, from a top plan view. A center aperture 104 is provided in the generally middle area of the shield member 102. As will be apparent below, the location of the aperture 104 is selected to align with the spray head 26 of the water fixture 10 and so that the shield member 102 is substantially co-extensive with the periphery of the toilet 12 when the fixture arm 20 is in a downward operational position. While this configuration is preferred, it is not required to carry out the present invention.

Still referring to FIG. 5, a longitudinally running channel 106 is recessed into the surface of the shield member 102, which may be carried out by molding, for example. As will be discussed in detail below, the spray head 26 of the water fixture 10 fits into the aperture 104 from above to direct water spray 22 downwardly therethrough while the arm 20 of the fixture 10 sits within the channel 106. A circumferential seat 102a is provided for the spray head 26 to prevent it from passing too far into the aperture 104 so the output side 26a of the spray head 26 is located at a desirable depth below the surface of the shield member 102. The arm 20 of the water fixture 10 is held in place in the channel 106 by at least retention member 108, which is preferably a strap-like clamp member that is secured on opposing sides of the channels with fasteners 110, such as screws and nuts, rivets, zip ties, and the like. The straps 108 preferably have an arched middle portion 108a to provide additional contact surface to the arm 20 of the water fixture 10 for additional clamping action. It should be noted that the shape, configuration and number of clamping members 108 may be modified to suit the application at hand.

Referring now to FIG. 6, a bottom perspective view of the shield device 100 of FIG. 5 is shown. The shield member 102 includes a downwardly depending wall 102b about its periphery as well as a downwardly depending wall 102c about the aperture 104 to help guide and retain the spray head 26 of the water fixture 10. The wall 102c about the aperture 104 may be sloped inwardly in a funnel-like configuration to assist location of the spray head 26 of the fixture into the aperture 104. In FIG. 6, the bottom of the channel 106 can be seen, which supports and contains the arm portion 20 of the water fixture 10. The opposing ends of the fasteners 110, which are nuts in this preferred example, can also be seen.

As seen in both FIGS. 5-7, a front cutout of a front portion of the downwardly depending peripheral wall 102d is provided to assist in lifting up the shield device 100 to an upward stored position while the water fixture 10 is attached thereto.

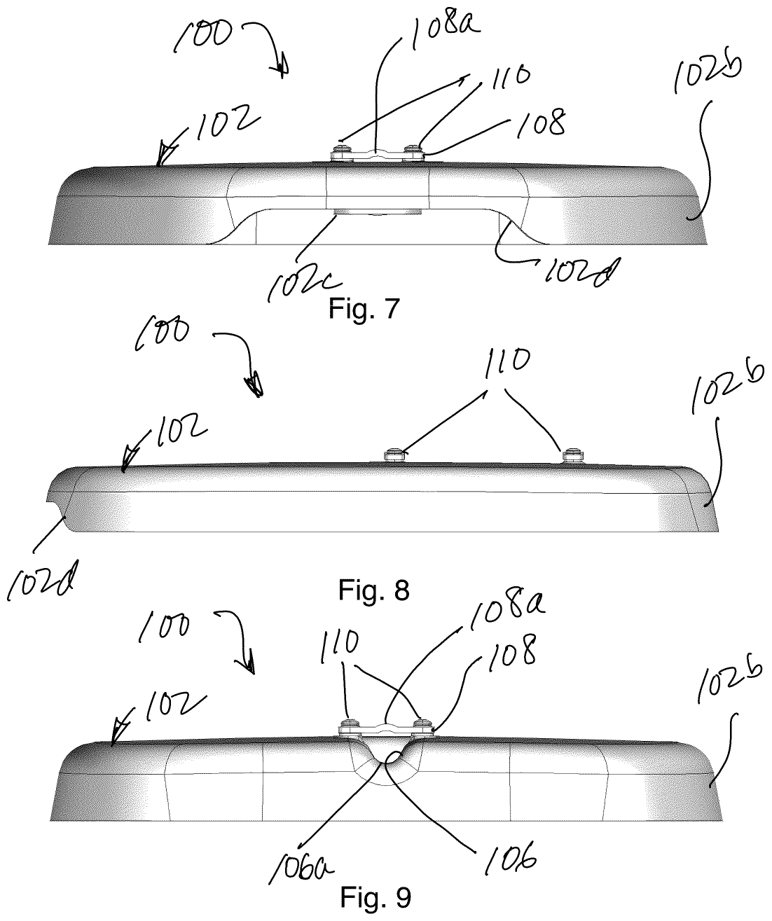

In FIG. 7, which is a front elevational view of the shield device 100 of FIG. 5, the clamp 108 closest to the aperture 104 can be seen as well as the bottom edge of the wall 102c about the aperture 104 in the shield member 102. FIG. 8, which is a right side elevational view of the shield device 100 of FIG. 5, fasteners 108 can be seen emanating above the shield member 102. In FIG. 9, which is a rear elevational view of the shield device of FIG. 5, the end and configuration of the channel 106 can be seen in detail. Preferably, the floor 106a of the channel 106 is of an arcuate shape that approximates the arcuate shape of the arm 20 of the water fixture 10. It is possible to modify the location, shape and configuration of the aperture 104 and channel 106 to accommodate different sizes and configurations of water fixtures 10. Also in FIG. 9, the strap clamp 108 that is farthest away from the aperture can be seen. The arched middle portion 108a of the straps 108 can be seen in both FIGS. 7 and 9 as well.

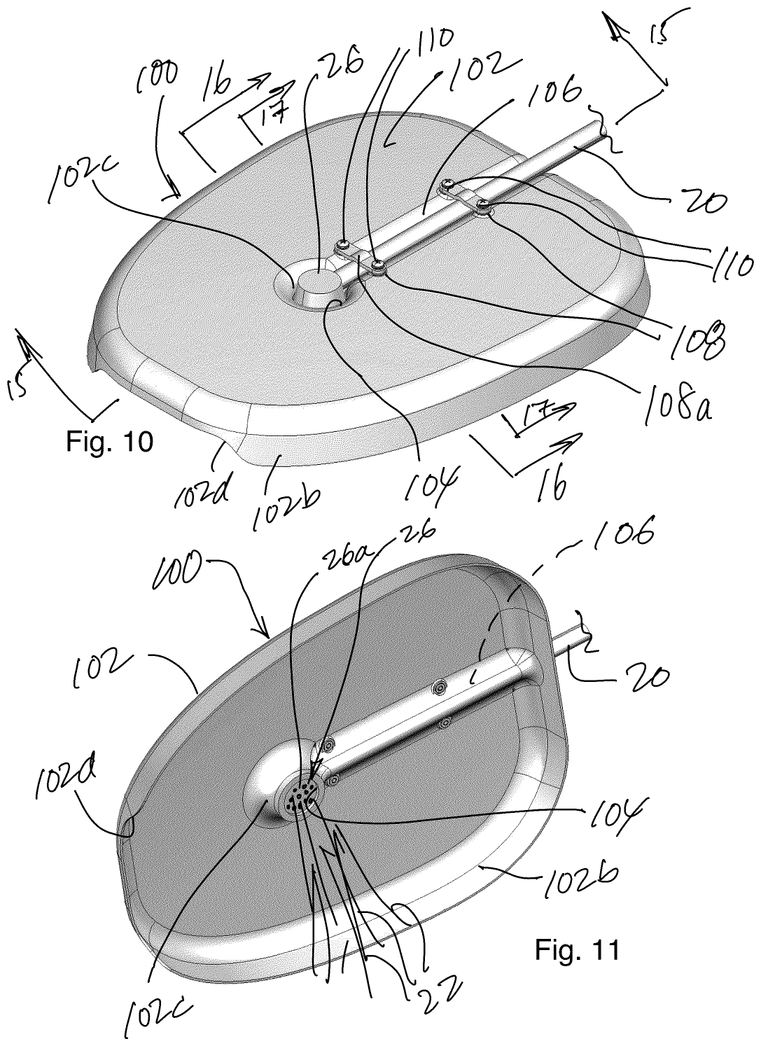

Referring now to FIGS. 10-17, various views of the shield device 100 of the present invention can be seen as installed on an existing bed pan water fixture 10.

In FIG. 10, a top perspective view of the shield device 100 of the present invention with a bed pan cleaning water fixture 10 installed therein, is shown. The arm portion 20 of the water fixture 10 sits within the channel 106 and the spray head 26 of the fixture 10 sits within the aperture 104. The strap clamps 108 secure the arm portion 20 of the water fixture 10 into the channel 106 to secure it in place and prevent rotation thereof. The tight fit turns the sprayer arm 20 into a locating feature of the present invention.

FIG. 11 is a bottom perspective view of the shield device 100 of FIG. 5 with a bed pan cleaning water fixture 10 installed therein. In FIG. 11, the output surface 26a of the spray head 26 can be seen. As a result, water spray 22 emanates downwardly therefrom towards a bed pan 24 being held up against the bottom of the shield member 102 of the shield device 102. The fasteners 110 for the clamps 108 can also be seen in FIG. 11.

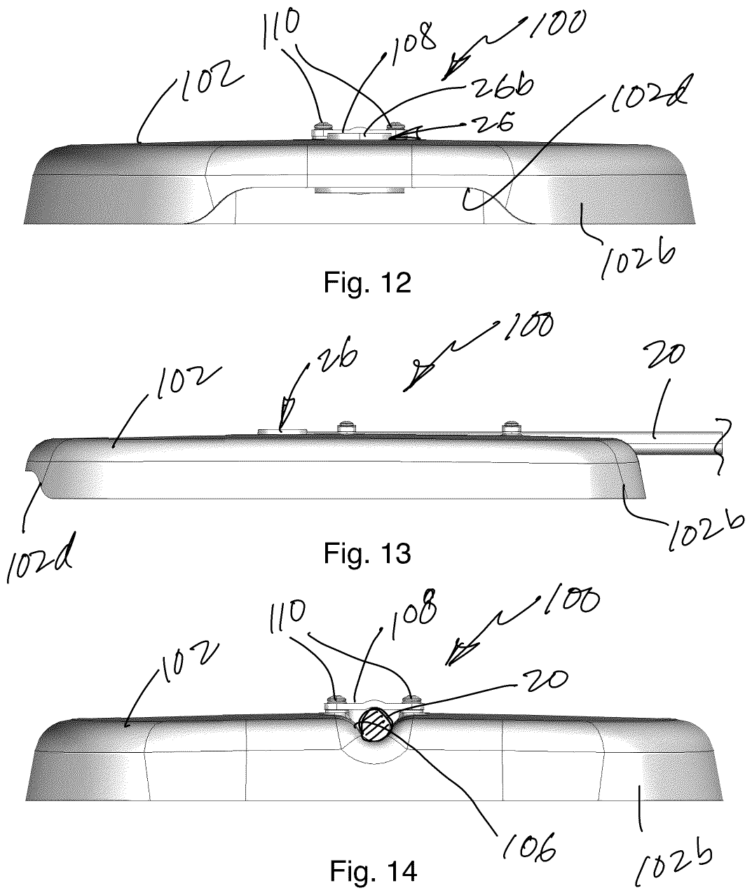

FIG. 12 is a front elevational view of the shield device 100 of FIG. 5 with a bed pan cleaning water fixture 10 installed therein. In FIG. 12, the top 26b of the spray head 26 can be seen emanating slightly above the shield member 102 of the shield device 100 with the clamps 108 secured to lock the arm 20 and spray head 26 of the water fixture 10 in place.

FIG. 13 is a right side elevational view of the shield device 100 of FIG. 5 with a bed pan cleaning water fixture 10 installed therein. FIG. 13 shows the positioning of the arm 20 of the water fixture 10 being secured into the channel 106 by the clamps 108.

FIG. 14 is a rear elevational view of the shield device 100 of FIG. 5 with a bed pan cleaning water fixture 10 installed therein where arm 20 of the water fixture 10 can be seen with the clamps 108 securing the arm 20 in place in the channel 106.

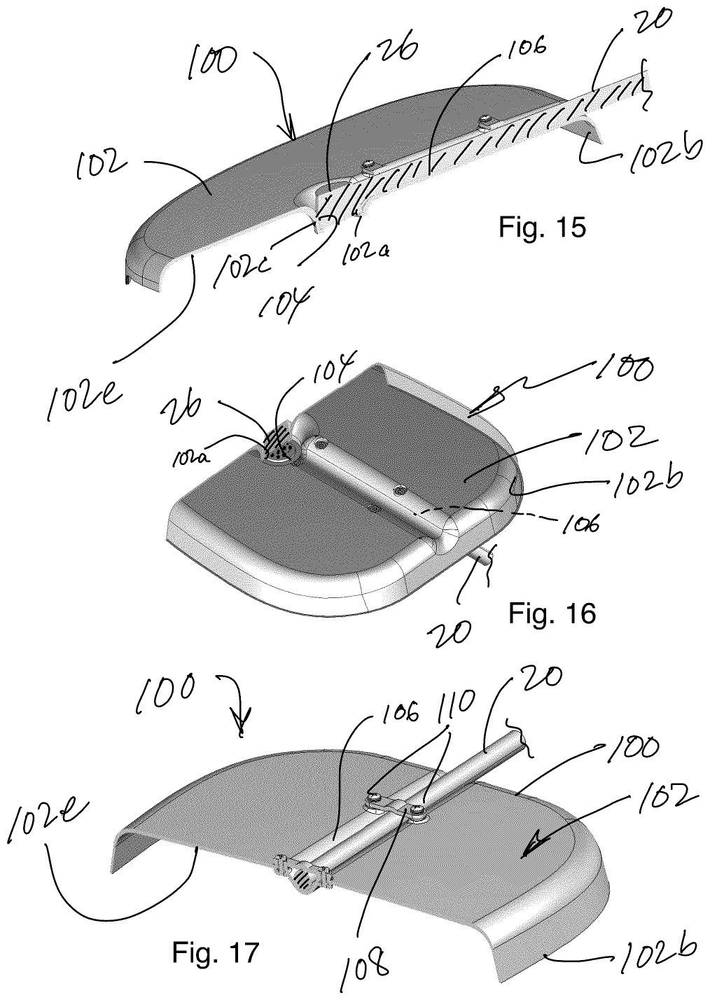

Still further, FIG. 15 shows a cross-sectional view through the line 15-15 of FIG. 10 to provide additional details of how the arm 20 sits in the channel 106 and the spray head 26 sits in the aperture 104 and resting on the circumferential seat 102a.

FIG. 16 is a cross-sectional view though the line 16-16 of FIG. 10 to provide additional details of how the spray head 26 sits in the aperture 104 and resting on the circumferential seat 102a.

FIG. 17 is a cross-sectional view through the line 17-17 of FIG. 10 to provide additional details of how the arm 20 of the water fixture 20 is secured into the channel 106 by the clamps.

FIGS. 18-22 show the device 100 in use to clean a bed pan 24 in accordance with the present invention.

FIG. 18 is a perspective view of the shield device 100 of the present invention installed on a water fixture 10 on a toilet 12 that is in a stowed upright position. In FIG. 18, the water fixture arm 20 is in an upright stored position with the shield device 100 attached thereto. With the fixture arm 20 in this position, water 22 is not diverted to the arm 20 of the water fixture 10 and out through the spray head 26. Instead, the shield device 100 is connected to the arm 20 and spray head 26 of the fixture 10 and neatly stores away in this non-use position.

FIG. 19 shows a perspective view of the shield device 100 of the present invention installed on a water fixture 10 on a toilet 12 that is in a lowered in-use position. With the water fixture 10 in this position, with the shield device 100 attached thereto, water 22 is diverted through the arm of the fixture 10 and then out through the spray head 26. In this position, when the toilet valve 16 is actuated, water 22 flows through the spread head 26 and downward to toward the toilet 12. In this lowered horizontal position, the water fixture 10 and shield device 100 of the present invention is ready for use

In FIG. 20, which is a perspective view of the water fixture 10 in a lowered in-use position with shield device 100 attached thereto during cleaning of a bed pan 24, the bed pan 24 to be cleaned is moved underneath the spray head 26 of the water fixture 10 and completely underneath the device 100 of the present invention. The aperture 104 in the shield member 102 locates the spray head 26 to the approximate center of the bed pan 24 when the bed pan 24 is located within the confines of the peripheral side wall 102b of the shield member 102 of the shield device 100. The toilet valve 16 is flushed and sprayed water 22 is directed into and toward the bed pan 24 to carry out the cleaning operation. In particular, the bed pan 24 can be pressed up into the lower side 102e of the shield member 102 of the shield device 100 to further avoid splashing and exposure to the contents of the bed pan 24 from a patient. This configuration, along with the downwardly depending side wall 102d significantly reduces or eliminates the caregiver from exposure to the contents of the bed pan 24 during the cleaning process.

In FIG. 21, a perspective view of the water fixture 10 and shield device 100 attached thereto being pivoted up and away after cleaning, washing is complete and the water fixture 10 is pivoted back up and out of the way and, since the shield device 100 of the present invention is attached directly to the water fixture arm 20, it pivots up and out of the way with the water fixture arm 20. In FIG. 22, which is a perspective view of the water fixture 10 and shield device 100 attached thereto in an upright stowed position while the bed pan 24 is being emptied, the water 22 and debris in the bed pan 24 are emptied in the toilet 12 for disposal by flushing. If the bed pan 24 is not sufficiently clean, the fixture 10 and shield device 100 can be pivotally downwardly again as in FIG. 20 for a subsequent cleanings, as needed.

In view of the above, the shield device 100 of present invention greatly reduces or eliminates back splash of liquid and other debris up toward the user thereby making the bed pan cleaning process cleaner and safer for the user.

The device 100 of the present invention is preferably made of plastic, such as by injection molding, for ease and speed of manufacturing and to reduce cost of the device. The device 100 may be made of other materials, such as metal. The retention clamp members 108 may be plastic or metal and the fasteners that retain the clamp members 108 in place may be threaded fastener and nuts made of metal or other materials, such as plastic.

The aforesaid examples are only some of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. A shield device for a bed pan during cleaning using a pivoting water fixture having an arm and a head, comprising:
a shield member defining an aperture and a peripheral edge; the center aperture being defined by an inner edge and being configured and arranged to receive the head of the water fixture therein and permit flow of water through the aperture; the shield having a rear edge;
a channel disposed in the shield and being configured and arranged to receive the arm of the water fixture;
whereby the shield member is connected to the arm and head of the water fixture and moves with pivoting movement of the water fixture;
whereby when the water fixture is in a downward cleaning position, the shield member is positioned over the head of the water fixture to prevent upward splashing of water and debris up from the bed pan toward a person cleaning the bed pan using the water fixture.

2. The shield device of claim 1, wherein the channel extends from the center aperture to the rear edge of the shield.

3. The shield device of claim 1, further comprising at least one retention member attached to the shield and spanning across the arm thereby retaining the arm in the channel and maintaining the shield affixed to the water fixture.

4. The shield device of claim 1, wherein the at least one retention member is a clamp secured to the shield with fasteners on opposing sides of the channel.

5. The shield device of claim 1, wherein the shield member is made of plastic or metal.

6. The shield device of claim 1, wherein the retention member is made of plastic or metal.

7. The shield device of claim 1, wherein the shield member includes an outer wall downwardly depending from the peripheral edge of the shield member.

8. The shield device of claim 1, wherein the shield member includes an inner wall downwardly depending from the inner edge of the of the shield member.

9. The shield device of claim 1, wherein the central aperture is substantially circular and configured and arranged to receive a circular head of a water fixture.
